(19) United States
(12) Patent Application Publication
(10) Pub. No.: US 2014/0047042 A1
(43) Pub. Date: Feb. 13, 2014

(54) METHOD AND A SERVER FOR ROUTING BETWEEN DEVICES OF A COMPUTER BASED SOCIAL NETWORK

(71) Applicants: Harald Steck, Campbell, CA (US); Xiwang Yang, Brooklyn, NY (US); Yong Liu, Brooklyn, NY (US)

(72) Inventors: Harald Steck, Campbell, CA (US); Xiwang Yang, Brooklyn, NY (US); Yong Liu, Brooklyn, NY (US)

(73) Assignees: Polytechnic Institute of New York University, Brooklyn, NY (US); Alcatel-Lucent USA Inc., Murray Hill, NJ (US)

(21) Appl. No.: 13/571,967

(22) Filed: Aug. 10, 2012

(51) Int. Cl. H04L 12/58

(52) U.S. Cl. CPC H04L 51/32
USPC 709/206

(57) ABSTRACT

The invention concerns a method and a server for routing between devices of a computer based social network having a plurality of users, wherein upon receipt of a first message from a device (110) associated with a user (u1), a second message is sent to another device (104, 110), wherein the other device (104, 110) is selected from a plurality of predetermined devices depending on the result of an evaluation of at least 1 trust value (S(c,u1;uM)) associated with the user (u1), a category (c) of content of the computer based social network and another user (uM) of the computer based social network.

### FIELD OF THE INVENTION

The invention relates to a method and a server for routing between devices of a computer based social network.

### BACKGROUND

In computer based social networks multiple devices, e.g. servers and clients act together to allow users to access items of interest like texts, images, video or audio via the computer based social network. The items are for example either stored on a data base of the computer based social network or made available in real time via the computer based social network.

To access content a user may use the client, e.g. a mobile phone with a web browser, to request content of interest from a server or from another client used by another user of the computer based social network. The content of interest may be sent to the requesting client after it is determined by the server or by the other client. To that end messages are for example exchanged between the affected devices using for example routing protocols and routing tables.

### SUMMARY

The main idea of the invention regards routing between devices of a computer based social network, wherein upon receipt of a request message from a first device associated with a user, a second message is sent to another device, wherein the other device is selected from a plurality of predetermined devices depending on the result of an evaluation of at least one trust value associated with the user, a category of content of the computer based social network and another user of the computer based social network.

Advantageously the trust value of the user towards the other user is evaluated in the category by assigning the trust value a value proportional to the amount of ratings of the other user for items in the category and at least one other rating by the other user for at least one other item in at least one other category.

Advantageously the trust values are evaluated by setting an equal value, in particular One, to the trust values of the user towards the other user if the user and the other user have a social link and if the user and the other user have rated an item in the same category.

Advantageously a value higher than a predetermined threshold is assigned to the trust value of the user towards the other user for a category when the user and the other user have assigned a respective predetermined amount of ratings to items in the category.

Advantageously a predetermined value is assigned to the trust value if the amount of ratings assigned by the other user to items in the category exceeds a predetermined threshold.

Advantageously evaluating comprises of comparing trust values, and from the plurality of predetermined devices the device being associated with the other user having a trust value indicating the highest trust of all other users is selected.

Further developments of the invention can be gathered from dependent claims and the following description.

### BRIEF DESCRIPTION OF THE FIGURES

In the following the invention will be explained further making reference to the attached drawings.

FIG. 1 schematically shows part of a computer network.

FIG. 2 schematically shows a flow chart.

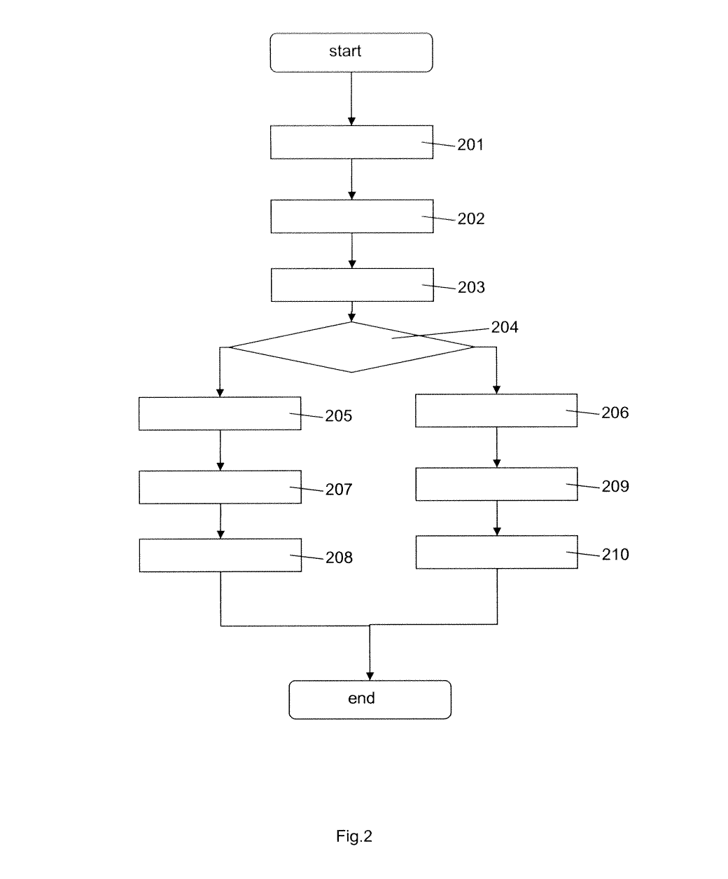

### DESCRIPTION OF THE EMBODIMENTS

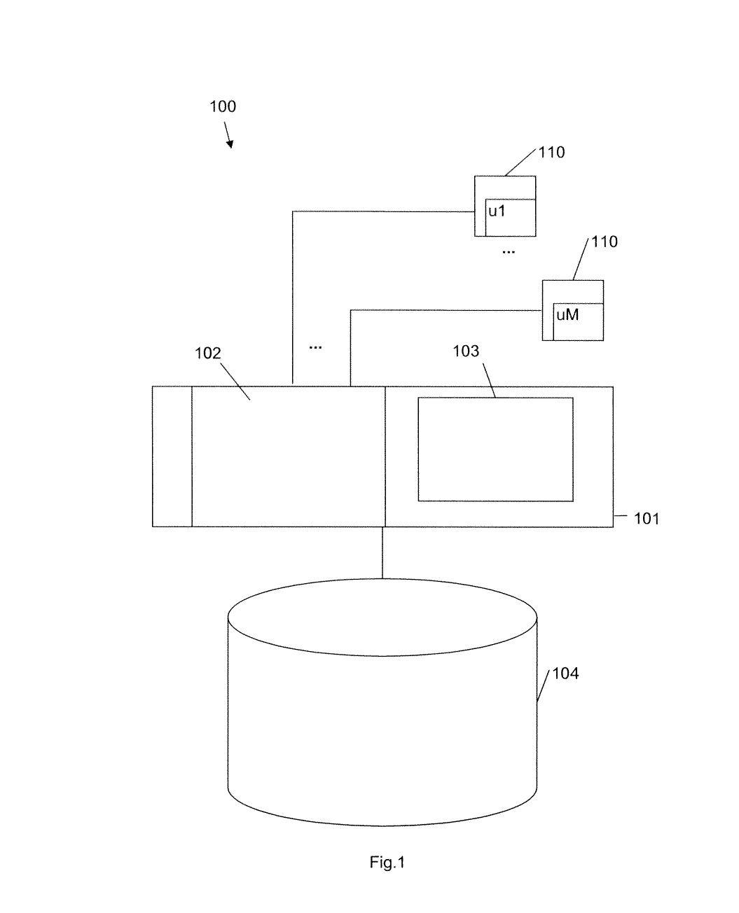

FIG. 1 shows a first part of a computer network 100.

The computer network 100 comprises a server 101. The server comprises a sender/receiver 102 and a processor 103.

Furthermore the server 101 comprises storage, not depicted in FIG. 1, and is adapted to access a data base 104. The data base 104 may be integrated into the server 101.

The computer network 100 comprises 1 or more clients 110 usable by several users u1, . . . uM. The number of users M or clients 110 is not limited according to the example.

One client 110 used by a user u1 is described as example. The other clients have the same functionality. The client 110 is for example a device like a smart phone or a personal computer comprising a graphical user interface and input means like a touch screen or a keyboard to be used as output and input device. A web browser installed on the client 110 may be used for example to access the computer based social network.

The client 110 is connectable at least temporarily to the server 101 via the computer network 100.

The connection is for example via local area network (LAN), wireless local area network (WLAN, 802.11n) or wide area network (WAN). The connection is for example according to the well known internet protocol (IP), user datagram protocol (UDR), transmission control protocol (TCP) or stream control transmission protocol (SCTP). Signaling is for example according to the well known Simple Object Access Protocol (SOAP), Representational State Transfer (REST) or session initiation protocol (SIP) or Internet Protocol Multimedia Subsystem (IM). Addressing may be done using the well known uniform resource locators (URL), uniform resource identifiers (URI), names or namespaces of extensible markup language (XML Version 1.0, Third Edition, W3C Recommendation 8 Dec. 2009).

The connection can but must not be directly between the client 110 and the server 101. The typical use is on wide area networks with multiple intermediate devices.

Instead of a single server 101 distributed servers may be used as well, e.g. a computing cloud.

The data base 104 comprises content of the computer based social network, e.g. items that can be divided into different categories. For example digital representations of books are stored as items. Furthermore the data base 104 is adapted to store information about ratings of users of the computer based social network for the items.

The server 101 is adapted to store this information and representations of users u1, uM of the computer based social network for example as data sets in the data base 104.

The data set for example comprises

a user name,

credentials for identification or authentication, e.g. user name and password,

information about social links to other users

information about ratings of the user for items.

This list is not exhaustive, other information may be stored as well. The items are differentiated according to categories as will be described below.

Access to the computer based social network is for example granted to the user u1 after successful identification and authentication against the authentication information stored in the data set of user u1. Identification or authentication processes like user name and password request processed for example using Digest Access Authentication or Public-key cryptography, are well known to the person skilled in the art and not explained in detail.

The social links represent a relationship of the users amongst each other. A social link from one user to another user is for example stored whenever a relationship between the two has been confirmed by both. The information about the social links is for example stored for a user u1 as a list of other users u2, uM selected by the user u1 from all users of the computer based social network upon confirmation by the respective other user u2, uM. Users linked by a social link are referred to as friend below.

The server 101 and the client 110 act together to allow users u1, uM to access content of the computer based social network, e.g. items like digital representations of books, texts, images, video or audio, via the computer network 100. Information between the server 101, the data base 104 or the client 110 is exchanged in the example according to the hyper text transfer protocol well known as HTTP. Furthermore the server 101 and the client 110 act together to perform authentication or identification of the users u1, . . . , uM.

The content contribution of the users u1, . . . uM is for example either stored on the data base 104 or made available in real time via 1 of the clients 110 currently connected to the computer network 100. In the latter case the content contribution is stored on the data base 104. The information about the content contribution that is stored in the data set is for example a link to the stored content contribution ion in the data base 104.

According to the example, to access content, the users u1, . . . , uM use one of the clients 110, e.g. the smart phone with the web browser, to send a request for content of interest in a first message to the server 101. This is explained below referencing user u1. The user u1 receives the requested content of interest in a second message via the requesting client 110.

To that end messages are for example exchanged between the affected devices according to the hyper text transfer protocol well known as HTTP.

The request may be entered by the users u1, . . . , uM via a the web browser. The response may be displayed via the web browser as well. The request and response may for example be structured and displayed using hypertext mark-up language version 5, well known as HTML5.

The client 110 is adapted to process the user input and determine the first message and send it to the server 101. The first message comprises of an identifier of the client 110 sending the request, information about the user u1 entering the request and information about the content of interest. The content of interest may be described as a text string, e.g. a question or a search term.

The receiver 102 is adapted to receive the first message and the sender 102 is adapted to send a second message. The second message comprises of information about the content of interest and information about the requestor. The information about the requestor for example is the information about the user u1 or the identifier of the client 110 that sent the first message.

For routing between the devices an evaluation to select the recipient of the second message is performed. The server 101 is adapted to upon receipt of the first message select another device to that the second message is to be sent depending on the result of the evaluation.

The selection depending on the result of the evaluation is described below.

According to the example categories c1, . . . , cN of items are used to combine items regarding specific interests. The items are for example categorized into N categories (c1, c2, . . . cN). The number of categories N is not limited according to the example. Exemplary categories are: “video & DVD”, “books”, “Music”, “Video Games”, “Toys”, “Online Stores & Services”, “Software”, “Destinations”, “Cars”, “Kid's TV Shows”.

This may be done by automatically analyzing the content of the data base 104. This way finding content of interest or information about such content of interest is simplified to finding content of the same category.

Furthermore the computer based social network, is divided into several sub-networks, referred to as inferred circles of trust, each of which concerns a single category c of all categories c1, c2, . . . cN. The client 110 may be part of one or multiple sub-networks.

Inferring circles of trust is explained for an exemplary category c and referencing user u1 and uM.

For the user u1 for each category c a circle of trust is inferred depending on the information about social links of user u1 to other users u2, . . . , uM and the information about content items rated by the users u1, . . . , uM in the category c. The latter is an additional condition besides the fact that there exists a social link between the users: both users have to have rated items in category c; then they are in the circle of trust concerning category c. This way user u1 trust a friend only concerning certain categories but not regarding others. For instance, the circle of friends concerning “cars” may differ significantly from the circle regarding “kids' TV shows”.

Rate in this context may refer to any kind of user feedback, explicit feedback like ratings they assign to items, but also implicit feedback like purchasing a book, clicking on a link, playing a video or song.

For instance, a user may be an expert in jazz music if he purchased a certain number of jazz songs, or played them online. Hence buying or playing the jazz songs is rating them.

Below rating is used as general term for all these kinds of feedback of users towards items. A rating may be a decimal number value matching the amount of “like” clicks or times the item is bought or played online. Other types of rating may be used, like 1 star to 5 stars or the like.

Definition (Inferred Circle): According to the example user u1 is in the inferred circle of trust of a user uM for the single category c if and only if the following two conditions hold:

user u1 is a friend of user uM, i.e. has a social link with user uM. This may be represented by assigning a value higher than a predetermined threshold, e.g. 1, to the trust value S(c,u1;uM) of the user u1 for the single category c, and

user u1 and user uM both have some expertise in the category c. Expertise may be represented by the number of ratings the user u1 and the other user uM submitted for items in the category c. This means testing if the number of ratings for items in the category c that has been received, in particular from the user u1 or the other user uM, exceeds a predetermined threshold, e.g. 0.

Otherwise, user u1 is not in the inferred circle of trust of uM concerning the single category c.

Category specific social trust information is for example stored as trust value S(c,u1;uM) for the category c. Any other form of storing this information may be used as well.

This means for example for the user u1 assigning to the user u1 for the categories c1, c2, . . . cN trust values S(c1,u1;uM), . . . , S(cN,u1;uM). The trust values are for example initialized by the value 1 to resemble equal trust for all users in all categories.

The trust values between users in the same inferred circle of trust, based on category c, may be captured and stored for later use in a social trust matrix S. The social trust matrix S defines the trust relationship for each category and combination of users.

For example the value of the element of the social trust matrix S for a single category c between the user u1 and uM is S(c,u1;uM)=0 if user uM is not in the inferred circle of trust and S(c,u1;uM)>0 if user uM is in the inferred circle of trust for that category c. For a user u1 the trust values for all categories c1, c2, . . . cN are for example stored as part of the data set of the user u1.

In the following three examples of defining the values S(c1,u1;uM), . . . , S(cN,uM;u1) are described. For example the value S(c,u1;uM) is set to a value higher than the predetermined threshold, e.g. 0, when user uM is in the inferred circle of trust of user u1 regarding category c and to 0 if the user uM is not in the inferred circle of trust of user u1 for the category c. The predetermined threshold may be 1, or negative values may be used as well.

Equal Trust: In a first example an equal value, in particular 1, is set to all trust values S(c1,u1;uM), . . . , S(cN,u1;uM) of all other users uM that are in the circle of trust of the user u1 for the respective category c1, . . . , cN.

This is the simplest variant of defining trust values S(c1,u1;uM), . . . , S(cN,u1;uM), e.g. greater than 0, within inferred circles of trust regarding item category. This means that each user u2, . . . , uM that is rated by the user u1 to be in the inferred circle of trust of user u1 gets assigned the same trust value. The rating in this case is for example the decision by the user u1 to establish a social link with the other user uM having rated items in the same category as the user u1.

This means that the trust values S(c1,u1;uM), . . . , S(cN,u1;uM) are evaluated by setting an equal value, in particular One, to the trust values S(c1,u1;uM), . . . , S(cN,u1;uM) of the user u1 towards the other user uM if the user u1 and the user uM have a social link and if the user u1 and the other user uM have a rated item in the same category c.

Expertise-based Trust: A second example is explained in two variants of assigning different trust values to users within the inferred circle of trust. The goal is to assign a higher trust value or weight to the users that are experts in the trust circle for the category c.

In the second variant directed trust relationships are considered to define the inferred trust circle. Undirected/mutual trust relationships (e.g., friendship) can be viewed as a special case of directed trust. The fact that user u1 trusts the other user uM in this context is described as a directed link from user u1 to the other user uM. Another directed rink from the other user uM back to user u1 may exist. In that case the user uM trusts user u1. In computer based social networks trust may be expressed by following another user.

At first an expertise level is assigned to the users for each category. This is explained for the user u1 as an example.

The expertise level may be computed from the number of ratings of the user u1 for items in the category c as described below. The numbers of ratings the user u1 assigned to items in the category c is for example used as an approximation to the level of expertise. The idea is that an expert in category c may have rated more items in that category than users who are not experts in that category c. The expertise level of the user u1 is for example stored for each category c1, . . . , cN in the data set for the user u1 as information about the ratings for items.

As example two variants for calculating the expertise level and trust value of user u1 are described for the category c and the relationship between user u1 and uM:

According to the first variant the expertise level for user u1 in category c is equal to the number of ratings that user u1 assigned to items in category c. For example the expertise level is 0 in case no rating has been assigned by user u1. For example the amount of ratings for items in category c is counted and, if more than 0 ratings have been assigned by the user u1 the expertise level is set to a value above a predetermined threshold, e.g. 0. The expertise level is set for example proportional to the number of rating counts. The expertise level is mapped to the trust values S(c,uM;u1) to result in the trust values S(c,uM;u1) being 0 in case the user u1 is not in the circle of trust of user uM and in the trust value S(c,uM;u1) being 0 in case user u1 has no ratings assigned in the category c.

According to the second variant, the expertise level of user u1 in category c is the product of two components.

The first component is determined as the number of ratings that user u1 assigned to items in category c as described above.

The second component is a voting value assigned to the user u1 depending on the number of ratings made by members of the circle of trust of user u1 for items in the category c.

The voting value for user u1 is determined from the amount of ratings the other users uM that trust user u1 assigned to items in the category c. For user uM as example the voting value for category c is the number of ratings of user uM for items in category c divided by the sum of the ratings for items in all categories c1, . . . , cN. For example if user uM has only ratings for items in category c, the voting value equals 1 for this category c. The voting value is for example less than 1 in case the user uM has several ratings for items in categories c1, . . . , cN but not all of them in category c. The voting value is for example 0 in case the user uM has no rating for items in category c. The individual voting values of all other users u2, . . . , uM are calculated this way for all other users having the respective directed social link or a mutual social link with user u1. Then the individual voting values for these users are summed up to the overall voting value for user u1 in category c.

The product of the two components is calculated afterwards as the expertise level.

This means that if most users that trust user u1 gave lots of ratings for items in category c it is a good indication that user u1 is an expert in category c. The expertise level is then mapped to the trust value S(c,uM;u1) to result in trust values S(c,uM;u1) being either 0 in case the user u1 is not in the inferred circle of trust of user uM or in case the expertise level of user u1 is 0. In any other case the result is for example the product of the values of the first and second component, i.e. the expertise level.

This means generally for both variants assigning a predetermined value to the trust value S(c,u1;uM) of the user u1 towards the other user uM for a category c if the amount of ratings assigned by the other user uM to items in the category c exceeds a predetermined threshold, e.g. 0.

Trust Splitting: In a third example the trust value S(c1,u1;uM) of the user u1 towards the other user uM in a category c1 is evaluated by assigning the trust value (S(c1,u1;uM)) a value proportional to the amount of ratings of the other user uM for items in the category c1 and at least one other rating by the other user (uM) for at least one other item in at least one other category c2, . . . cN.

This is referred to as trust splitting and is explained using user u1, user uM, category c1, category c2 and the trust values S(c1,u1;uM) and S(c2,u1;uM) as example:

User uM is in the trust circle of user u1 and user uM assigned ratings already to items in category c1 and c2. Assume the number of ratings of user uM for items in category c1 and c2 are 9 and 1 respectively. This means that the other user uM assigned 10 ratings in total. Then the trust values S(c1,u1;uM) and S(c2,u1;uM) of user u1 towards the other user uM are calculated depending on the distribution of the 10 ratings of user uM in the categories c1 and c2. This results in the example to trust splitting with values of S(c1,u1;uM) and S(c2,u1;uM) to be 9/10=0.9 and 1/10=0.1 respectively.

This means that the processor 103 is adapted to determine the trust value of a user u1 towards another user uM, e.g. S(cN,u1;uM), . . . , S(cN,u1;uM)), from at least one rating of the user u1, or from at least one rating of at least one other user, e.g. uM, of the computer based social network. The ratings according to the example are received via the receiver 102, processed and the result is stored as the trust value for the user, e.g. S(c1,u1;uM), . . . , S(cN,u1;uM).

Furthermore the server 101 is operable to upon receipt of the first message from the device associated with the user u1, e.g. the client 110 being currently used by user u1, send the second message to the other device, e.g. another client 110 or the data base 104, wherein the other device is selected from the plurality of predetermined devices, e.g. all clients 110 and the data base 104, depending on the result of the evaluation of the at least one trust value S(c,u1;uM) associated with the user u1, the category c of content of the computer based social network and the other user uM of the computer based social network.

For example the server 101 comprises the processor 103 adapted to select the other device, e.g. the data base 104 or the client 110 from a plurality of predetermined devices, e.g. the data base 104 or the clients 110 depending on the result of the evaluation.

Additionally in each of the examples or variants the trust values S(c1,u1;uM, . . . , S(cN,u1;uM) may be normalized. For example each element of a row of the trust matrix S is divided by the sum of all elements of the same row. This ensures that the weight across all users u2, . . . , uM is normalized to Unity in each circle of trust.

In the following a method for routing based on the determined category specific social trust information is explained referencing users u1, u2 and uM. According to the example users u1, u2 and uM have rated already several times items of the computer based social network. Rated content or content to rate is accessible via said data base 104. Furthermore user u2 has rated the most items of all users uM in the category “Software” and uM has rated the most items of all users u1, . . . , uM in category “cars”. Furthermore u1 has a social link to u2 and uM in the computer based social network. This information is available for example by accessing the respective data set.

The method starts for example when the first message comprising the request for an item of interest is received from the client 110 currently used by user u1.

After the start a step 201 is executed.

In step 201 the social trust matrix S is generated as described above. Generally this is referred to as assigning the trust value S(c1,u1;uM) a value. The value that is assigned depends on the method for calculating the social trust matrix S. As described above the value is assigned for example proportional to the amount of ratings of the other user uM for items in the category cl and at least one other rating by the other user uM for at least one other item in at least one other category c2, . . . cN. Or, in another example the value is assigned as the predetermined value if the amount of ratings assigned by the other user uM to items in the category c exceeds the predetermined threshold. In yet another example the assigned value is higher than the predetermined threshold when the user u1 and the other user uM have assigned a respective predetermined amount of ratings to items in the category c.

Alternatively an existing social trust matrix S may be read from storage.

Afterwards a step 202 is executed.

In the step 202 from the first message the category c that the request comprised in the first message is related to is determined from the categories c1, . . . , cN. For example the request contains the word “automobile” and is therefore related to the category “cars” by a recommender System. Such Recommender Systems for example using the K-Nearest Neighbour algorithm are known to the person skilled in the art and not further explained here. Afterwards a step 203 is executed.

In step 203 the trust values S(c,u1;u2), . . . , S(c,u1;uM) are looked up in the trust matrix S for the user u1, the category c and the other users u2, . . . , uM. The trust values are compared and the user having the trust value indicating the most trust of all users of the inferred circle of trust is selected. For example user uM has the most ratings of all users for items in the category “cars”. Hence in the example user uM gets assigned the trust value S(c,u1;uM)=1. All other users get trust values according to their individual ratings. For example user u2 is assigned the trust value S(c,u1;u2)=0 because there is no rating of user u2 in the category “cars”. In the example user uM has the highest trust value of all users u2, . . . , uM and is therefore selected. Preferably weighted average calculation over the trust values of the users in the circle of trust is used to select a user u1, . . . , uM. The weight for the users u1, . . . , uM is their respective trust value S(c1,u1;uM, . . . , S(cN,u1;uM). Generally this means that evaluating comprises of comparing trust values (S(c1,u1;u2), . . . , S(cN,u1;uM)), and from the plurality of predetermined devices (104, 110) the device being associated with the other user (u2, . . . , uM) having a trust value (3(c1,u1;uM), . . . , S(cN,u1;uM)) indicating the highest trust of all other users (u2, . . . , uM) is selected. In particular the server 101 is adapted to perform this comparison. Afterwards a step 204 is executed.

In step 204 it is determined if the other user uM is currently connected to the computer network 100.

In case the other user uM is not currently connected to the computer network 100, e.g. if the server 101 determines from the data set user uM is not logged in a step 205 is executed. Otherwise, e.g. if the server 101 determines from the data set user uM is logged in, a step 206 is executed.

In step 205 the second message is sent to the data base 104. Afterwards a step 207 is executed.

In step 207 the item is for example determined from data previously received by the server 101. To that end the data base 104 is adapted to store items and to determine from the stored items and the second message the item of interest. The item of interest is for example selected as relevant for the user u1 if it is within category c and by user uM. The relevant category c is determined for example from the information about the content of interest received in the second message. At least one item rated by the other user uM is determined as item of interest to user u1. For example a text rated by user uM in category “cars” is read from the data base 104.

Afterwards a step 208 is executed.

In step 208 a response to the second message is sent either via the sender/receiver 102 of the server 101 or directly to the client 110 having sent the first message. The response may comprise the item of interest or information about the item of interest requested in the first message.

Afterwards the method ends.

In step 206, i.e. the case that the other user uM is currently connected to the computer network 100, the second message is sent to the client 110 the user uM is currently using to connect to the computer based social network. Afterwards a step 209 is executed.

In step 209 the request for an item of interest is for example displayed to the user uM and the user uM is prompted to enter the item of interest. The request may he displayed with information about the category c. In that case the relevant category c is determined for example from the information about the content of interest sent in the second message. Afterwards a step 210 is executed.

In step 210 the response to the second message comprising the item of interest or information about the item of interest is sent to the client 110 used by the user u1 afterwards.

The response to the second message is sent either via the server 101 or directly to the client 110 used by the user u1.

Afterwards the method ends.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as ‘processors’, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term ‘processor’ should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts represent various processes which may be substantially represented in computer readable medium and so executed by a computer or processor, whether or not such computer or processor is explicitly shown.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A method for routing between devices of a computer based social network, wherein upon receipt of a first message from a device associated with a user, a second message is sent to another device, wherein the other device is selected from a plurality of predetermined devices depending on the result of an evaluation of at least one trust value associated with the user, a category of content of the computer based social network and another user of the computer based social network.

2. The method according to claim 1, comprising
evaluating the trust value of the user towards the other user in a category by assigning the trust value a value proportional to the amount of ratings of the other user for items in the category and at least one other rating by the other user for at least one other item in at least one other category.

3. The method according to claim 1, comprising
evaluating the trust values by setting an equal value, in particular One, to the trust values of the user towards the other user if the user u1 and the user have a social link and if the user and the other user have rated an item in the same category.

4. The method according to claim 1, comprising
evaluating the trust value by assigning a value higher than a predetermined threshold to the trust value of the user towards the other user for a category when the user and the other user have assigned a respective predetermined amount of ratings to items in the category.

5. The method according to claim 4, comprising
evaluating the trust value of the user towards the other user in a category by assigning a predetermined value to the trust value if the amount of ratings assigned by the other user to items in the category exceeds a predetermined threshold.

6. The method according to claim 1, comprising
evaluating which comprises comparing trust values, and from the plurality of predetermined devices the device being associated with the other user having a trust value indicating the highest trust of all other users is selected.

7. A server for routing between devices of a computer based social network, operable to upon receipt of a first message from a device associated with a user, send a second message to another device, wherein the other device is selected from a plurality of predetermined devices depending on the result of an evaluation of at least one trust value associated with the user, a category of content of the computer based social network and another user of the computer based social network.

8. The server according to claim 7 comprising
a receiver adapted to receive the first message from the device,
a sender adapted to send the second message to the other device,
a processor adapted to select the other device from a plurality of predetermined devices depending on the result of the evaluation.

9. The server according to claim 7, operable to
evaluate the trust value of the user towards the other user in a category by assigning the trust value a value proportional to the amount of ratings of the other user in the category and at Least one other rating by the other user for at least one other item of the other user in at least one other category.

10. The server according to claim 7, operable to—evaluate the trust values by setting an equal value, in particular One, to the trust values of the user towards the other user it the user and the user have a social link and if the user and the other user have rated an item in the same category.

11. The server (101) according to claim 7, operable to evaluate the trust values by assigning a value higher than a predetermined threshold to the trust value of the user for a category when the user and the other user have assigned a respective predetermined amount of ratings to items in the category.

12. The server according to claim 7, operable to evaluate the trust values by—evaluating the trust value of the user towards the other user in a category by assigning a predetermined value to the trust value if the amount of ratings assigned by the other user to items in the category exceeds a predetermined threshold.

13. The server according to claim 7 operable to evaluate by comparing trust values, and from the plurality of predetermined devices the device being associated with the other user having a trust value indicating the highest trust of all other users is selected.

14. A computer program for routing in a computer based social network having a plurality of users, wherein said computer program, when executed on a computer, causes the computer to execute the method of claim 1.

15. A computer program product for routing in a computer based social network having a plurality of users comprising a computer usable medium having a computer readable program, wherein said computer readable program, when executed on a computer, causes the computer to execute the method of claim 1.
